(19) United States
(12) Patent Application Publication
(10) Pub. No.: US 2015/0279600 A1
(43) Pub. Date: Oct. 1, 2015

(54) ELECTROMAGNETIC RELAY

(71) Applicant: FUJITSU COMPONENT LIMITED, Tokyo (JP)

(72) Inventors: Nobuyoshi Hiraiwa, Tokyo (JP); Masato Morimura, Tokyo (JP); Kazuo Kubono, Tokyo (JP); Takashi Yuba, Tokyo (JP)

(21) Appl. No.: 14/666,499

(22) Filed: Mar. 24, 2015

(30) Foreign Application Priority Data
Mar. 28, 2014 (JP) 2014-069849

(51) Int. Cl. H01H 50/58

(52) U.S. Cl. CPC H01H 50/58; H01H 2205/002

(57) ABSTRACT

An electromagnetic relay includes a first fixed spring including a first fixed contact, a second fixed spring including a second fixed contact, a movable spring including a spring, a first movable contact is connected a first end of the spring, and a second movable contact is connected to a second end of the spring, and a conductive member, one end connected to the first movable contact and another end connected to the second movable contact.

### CROSS-REFERENCE TO RELATED APPLICATIONS

This application is based upon and claims the benefit of priority of the prior Japanese Patent Application No. 2014-069849 filed on Mar. 28, 2014, the entire contents of which are incorporated herein by reference.

### FIELD

The embodiments discussed herein are related to an electromagnetic relay.

### BACKGROUND

An electromagnetic relay is used in a circuit of an electrically-powered car, a hybrid car or the like for allowing electric current to flow or be interrupted in the circuit.

Typically, the electromagnetic relay includes a coil, a movable spring including a movable contact, and a fixed spring including a fixed contact. In the electromagnetic relay, a magnetic field is generated by allowing electric current to flow through the coil. The magnetic force of the magnetic field moves the movable spring so that the movable contact contacts the fixed contact. Thereby, electric current flows through a circuit by way of the electromagnetic relay. Further, when the magnetic field is terminated by interrupting electric current in the coil, the recovering force of the movable spring separates the contact between the movable contact and the fixed contact. Thereby, electric current is stopped from flowing by way of the electromagnetic relay.

### [Patent Document 1]: Japanese Laid-Open Patent Publication No. 2010-267470

### [Patent Document 2]: Japanese Laid-Open Patent Publication No. 2003-229033

### [Patent Document 3]: Japanese Laid-Open Patent Publication No. 2010-20975

### [Patent Document 4]: Japanese Laid-Open Utility Model Publication No. 1-86148

Because a large amount of electric current flows in a circuit of an electrically-powered car, a hybrid car or the like at a high voltage, the electromagnetic relay for such circuit is desired to handle larger current and higher voltage compared to a typical commercially available electromagnetic relay. Further, in order to install the electromagnetic relay in an electrically-powered car, a hybrid car or the like, the electromagnetic relay is desired to be inexpensive and small.

With a typical commercially available electromagnetic relay, the upper limit of the electric current allowed to flow is low. Therefore, in a case where the amount of electric current exceeds the upper limit, the electromagnetic relay may be heated and damaged.

### SUMMARY

According to an aspect of the invention, there is provided an electromagnetic relay includes a first fixed spring including a first fixed contact, a second fixed spring including a second fixed contact, a movable spring including a spring, a first movable contact is connected a first end of the spring, and a second movable contact is connected to a second end of the spring, and a conductive member, one end connected to the first movable contact and another end connected to the second movable contact.

### BRIEF DESCRIPTION OF DRAWINGS

FIG. 1 is a perspective view illustrating an electromagnetic relay according to a first embodiment of the present invention;

FIG. 2 is a perspective view illustrating an electromagnetic relay without a conductive member;

FIG. 3 is a schematic diagram for describing the electromagnetic relay of the first embodiment;

FIG. 4 is a schematic diagram for describing the electromagnetic relay of the first embodiment;

FIG. 5 is a schematic diagram for describing the electromagnetic relay of the first embodiment;

FIGS. 6A and 6B are schematic diagrams for describing a movable spring and a conductive member of the electromagnetic relay of the first embodiment;

FIG. 7A is a table illustrating a relationship between the amount of electric current flowing in the electromagnetic relay illustrated in FIG. 1 and the temperatures of respective parts of the electromagnetic relay 100 illustrated in FIG. 1;

FIG. 7B is a table illustrating a relationship between the amount of electric current flowing in the electromagnetic relay illustrated in FIG. 2 and the temperatures of respective parts of the electromagnetic relay illustrated in FIG. 2;

FIG. 7C is a graph illustrating a correlation between an electric current flowing in an electromagnetic relay and a temperature of a movable spring;

FIG. 8 is a schematic diagram for describing an electromagnetic relay according to a second embodiment of the present invention;

FIG. 9 is a schematic diagram for describing an electromagnetic relay according to a third embodiment of the present invention;

FIG. 10 is a schematic diagram for describing an electromagnetic relay according to a fourth embodiment of the present invention;

FIG. 11 is a schematic diagram for describing an electromagnetic relay according to a fifth embodiment of the present invention;

FIG. 12 is a perspective view illustrating another electromagnetic relay of the fifth embodiment;

FIG. 13 is a schematic diagram for describing the electromagnetic relay of the fifth embodiment;

FIG. 14 is a schematic diagram for describing the electromagnetic relay of the fifth embodiment;

FIG. 15 is a schematic diagram for describing the electromagnetic relay of the fifth embodiment;

FIG. 16 is a schematic diagram for describing the electromagnetic relay of the fifth embodiment; and

FIG. 17 is a schematic diagram for describing the electromagnetic relay of the fifth embodiment.

### DESCRIPTION OF EMBODIMENTS

In the following, embodiments of the present invention are described with reference to the accompanying drawings. Like components are denoted with like reference numerals and are not further explained.

### First Embodiment

An electromagnetic relay that is resistant to high voltage and capable of allowing a large amount of electric current to flow tends to be larger than a conventional electromagnetic relay. Such electromagnetic relay may be unsuitable for mounting on an electrically-powered car or a hybrid car or the like. Thus, an electromagnetic relay having the same or similar size and shape of a conventional electromagnetic relay but being resistant to high voltage and capable of flowing a large amount of electric current is desired.

### <Electromagnetic Relay>

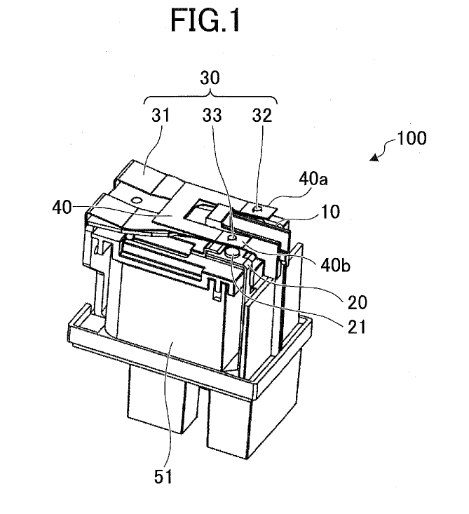

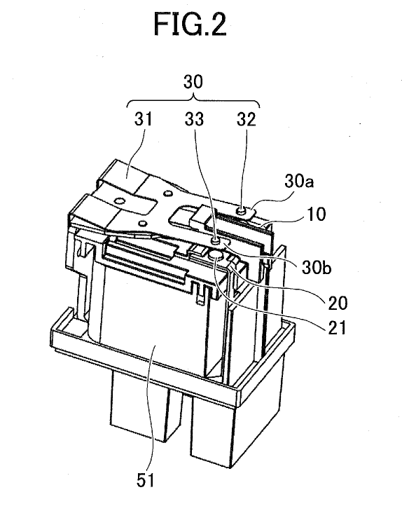

An electromagnetic relay according to a first embodiment of the present invention is described with reference to FIG. 1. As described below, the electromagnetic relay 100 of this embodiment is resistance to high voltage and includes a conductive member 40 formed of a conductive material (e.g., metal) for increasing the amount of electric current flow in a movable spring 30 of the electromagnetic relay 100. FIG. 1 is a perspective view illustrating the electromagnetic relay 100 of this embodiment. FIG. 2 is a perspective view illustrating an electromagnetic relay without a conductive member 40.

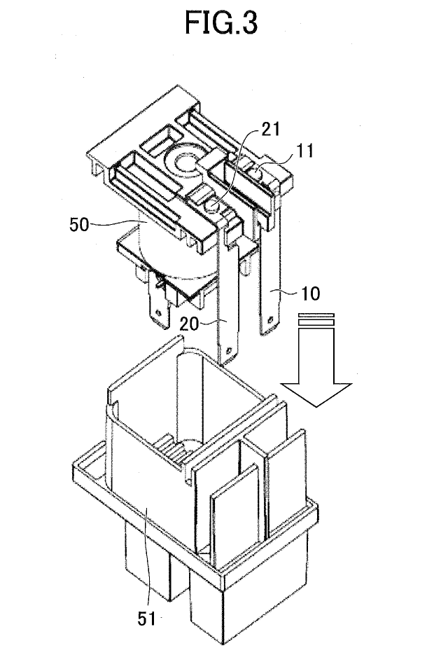

As illustrated in FIG. 1, the electromagnetic relay 100 of this embodiment includes a first fixed spring 10, a second fixed spring 20, a movable spring 30, and a conductive member 40. As described below with reference to FIG. 3A, a first fixed contact 11 is provided in the vicinity of an end of the first fixed spring 10, and a second fixed contact 21 is provided in the vicinity of an end of the second fixed spring 20. As illustrated in FIG. 2, the movable spring 30 includes a spring 31 formed of a metal plate or the like, a first movable contact 32 provided on an end 30a on one side of the spring 31, and a second movable contact 33 provided on an end 30b on the other side of the spring 31. The first movable contact point 32 of the movable spring 30 is formed in a position corresponding to a position of the first fixed contact point 11 of the first fixed spring 10, and the second movable contact point 33 of the movable spring 30 is formed in a position corresponding to a position of the second fixed contact point 21 of the second fixed spring 20.

In the electromagnetic relay 100 of this embodiment, a U-shaped conductive member 40 is connected to the first movable contact point 32 and the second movable contact point 33 of the movable spring 30. The conductive member 40 is formed into a U-shape and has one end 40a connected to the first movable contact point 32 and another end 40b connected to the second movable contact point 33.

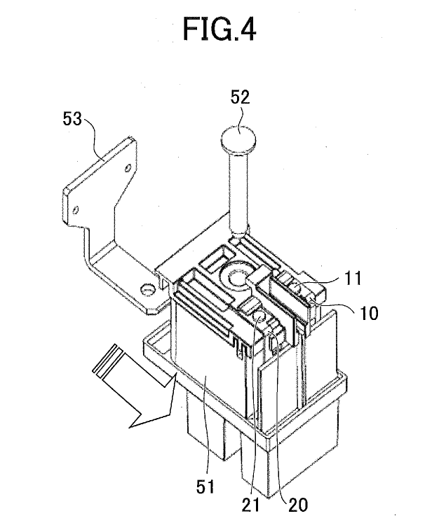

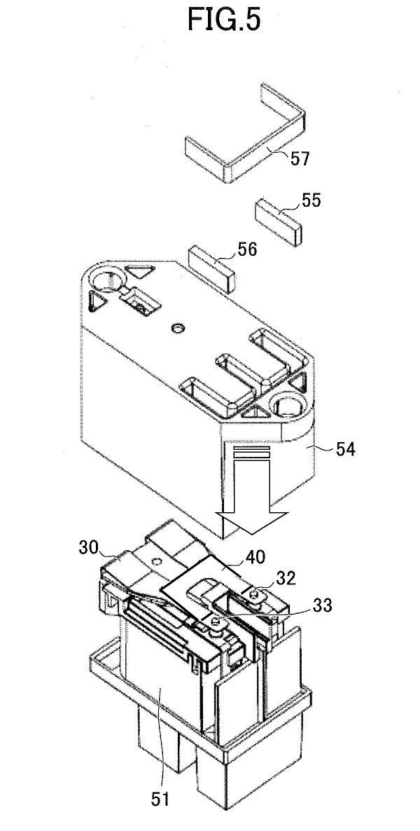

Next, the electromagnetic relay 100 is described in detail with reference to FIGS. 3 to 5. For the sake of explanation, a portion of the electromagnetic relay 100 is not illustrated in FIGS. 3 to 5. The electromagnetic relay 100 of this embodiment includes a coil 50 allowing an electric current to flow therethrough for generating a magnetic field. A portion of the electromagnetic relay 100 including the coil 50, the first fixed spring 10, and the second fixed spring 20 is installed in a base 51 as illustrated in FIG. 3. A lead wire is wound around the coil 50 for converging magnetic flux and generating a magnetic force in a desired direction. As illustrated in FIG. 4, a core 52 is provided in the center of the coil 50 wrapped by lead wire, and a yoke 53 is provided at an outer side of the coil 50. In this embodiment, after the movable spring 30 having the conductive member 30 connected thereto is set, the base 51, the conductive member 40, and the movable spring 30 is covered with a cover 54 as illustrated in FIG. 5. Permanent magnets 55, 56, and a yoke 57 are mounted on the cover 54. The base 51 and the cover 54 of this embodiment are made of a resin material. The base 51 and the cover 54 form a housing.

The magnetic force of the magnetic field generated by the electric current flowing through the coil 50 provided in the electromagnetic relay 100 causes the first fixed contact 11 of the first fixed spring 10 and the first movable contact 32 of the movable spring 30 to contact each other, and the second fixed contact 21 of the second fixed spring 20 and the second movable contact 33 of the movable spring 30 to contact each other. Thereby, electric current flows, for example, from the first fixed spring 10, then to the first fixed contact 11, then to the first movable contact 32, then to both the spring 31 and the conductive member 40, then to the second movable contact 33, then to the second fixed contact 21, and then to the second fixed spring 20.

Because the first fixed spring 10 and the second fixed spring 20 are not required to move, the first fixed spring 10 and the second fixed spring 20 may be formed with a material having a substantial amount of thickness. As the cross-section area of the first and second fixed springs 10, 20 can be increased, a large amount of electric current can flow through the first and second fixed springs 10, 20.

On the other hand, the spring 31 of the movable spring 30 is required to move to allow the first movable contact 32 to contact the first fixed contact 11 and the second movable contact 33 to contact the second fixed contact 21 when electric current is allowed to flow through the coil 50. Therefore, the spring 31 is to be formed of a material having a resilient property (e.g., plate spring) while being capable of providing a conductive property such as metal (e.g., copper). However, even when the spring 31 is formed of metal having both a resilient property and a conductive property, the spring 31 would be unable to exhibit its resilient property and serve as a spring if the spring 31 is too thick. Therefore, in this embodiment, the spring 31 is formed with a thickness of 0.25 mm.

In the electromagnetic relay 100 of this embodiment, the U-shaped conductive member 40 is formed by processing a metal plate made of copper or the like to have a shape similar to a portion of the spring 31. A thickness of the conductive member 40 is 0.25 mm, which is the same as the thickness of the spring 31. Therefore, the electromagnetic relay 100 allows electric current to flow approximately two times more compared to the electromagnetic relay without the conductive member 40.

The conductive member 40 is preferred to be formed of a material having high conductivity such as copper (Cu) or silver (Ag). Further, the conductive member 40 is preferred to have a thickness greater than or equal to the thickness of the spring 31. This is because the electric current that flow the conductive member 40 can be increased by increasing the thickness of the conductive member 40.

### <Conductive Member>

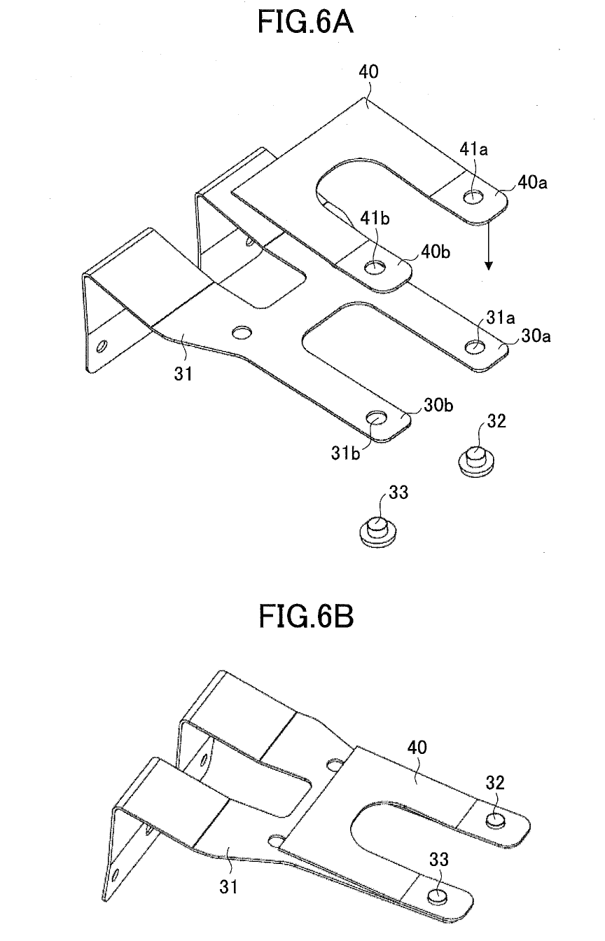

Next, a method for connecting the spring 31 of the movable spring 30 to the conductive member 40 is described with reference to FIGS. 6A and 6B. FIG. 6A illustrates a state prior to connecting the conductive member 40 to the spring 31. FIG. 6B illustrates a state where the conductive member 40 is connected to the spring 31.

When connecting the spring 31 of the movable spring 30 to the conductive member 40, the conductive member 40 is superposed on the spring 31. A portion of the spring 31 that contacts with the first fixed contact 11 and the second fixed contact 21 is formed in a U-shape. The width of the U-shaped portion of the spring 31 is approximately 4 mm. A connection hole 31a is formed at the vicinity of one end 30a of the U-shaped portion of the spring 31 whereas a connection hole 31b is formed at the vicinity of the other end 30b of the U-shaped portion of the spring 31. The conductive member 40 is also formed in a U-shape. A connection hole 41a is formed at the vicinity of one end 40a of the conductive member 40 whereas a connection hole 41b is formed at the vicinity of the other end 40b of the conductive member 40. The width of the conductive member 40 is approximately 4 mm.

The connection hole 41a formed on the one end 40a of the conductive member 40 is provided in a position corresponding to the position of the connection hole 31a formed on the one end 30a of the spring 31. The connection hole 41b formed on the other end 40b of the conductive member 40 is provided in a position corresponding to the position of the connection hole 31b formed on the other end 30b of the spring 31.

When superposing the conductive member 40 on the spring 31, the position of the connection hole 31a is to match the position of the connection hole 41a whereas the position of the connection hole 31b is to match the position of the connection hole 41b.

Then, the connection hole 31a and the connection hole 41a are connected to each other by fastening the connection hole 31a and the connection hole 41a with the first movable contact 32, and the connection hole 31b and the connection hole 41b are connected to each other by fastening the connection hole 31b and the connection hole 41b by caulking the second movable contact 33. Thereby, the spring 31 and the conductive member 40 are connected. By connecting the conductive member 40 to the spring 31, the resistance between the first movable contact 32 and the second movable contact 33 can be reduced, and the amount of electric current that can flow in the electromagnetic relay 100 can be increased.

### <Measurement Results>

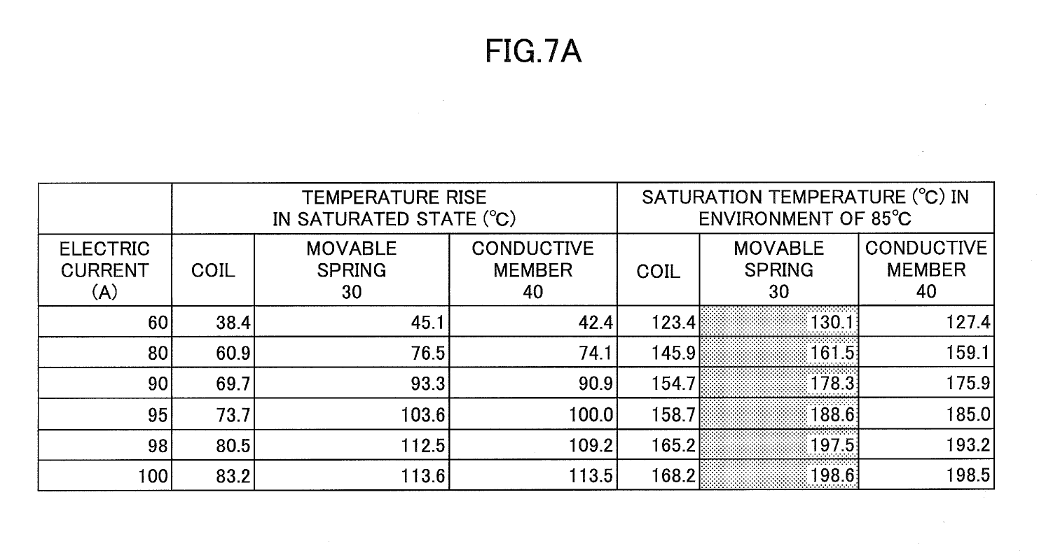

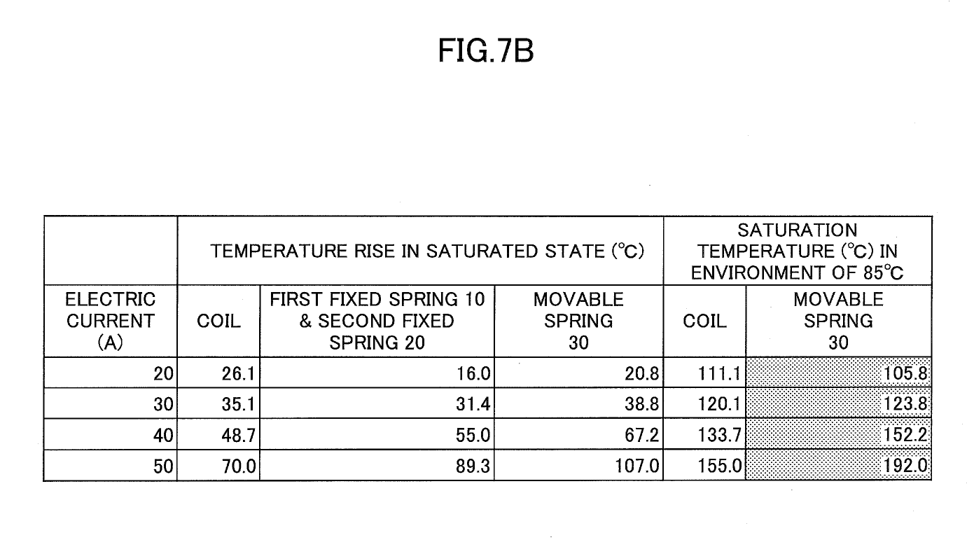

Next, temperatures measured when electric current flow in both of the electromagnetic relay 100 illustrated in FIG. 1 and the electromagnetic relay illustrated in FIG. 2 are described. The temperatures measured herein are saturated temperatures that are measured after flowing electric current in each of the electromagnetic relay for 1 hour. The measurement results indicate the temperature rise measured in respective parts of each electromagnetic relay, and the temperatures of the respective parts of each electromagnetic relay under an environment of 85° C. A thermocouple is used for measuring the temperatures. FIG. 7A shows a relationship between the amount of electric current flowing in the electromagnetic relay 100 illustrated in FIG. 1 and the temperatures of respective parts of the electromagnetic relay 100 illustrated in FIG. 1. FIG. 7B shows a relationship between the amount of electric current flowing in the electromagnetic relay illustrated in FIG. 2 and the temperatures of respective parts of the electromagnetic relay illustrated in FIG. 2.

As illustrated in FIGS. 7A and 7B, the temperatures in respective parts in each of the electromagnetic relays increase as the amount of electric current flowing in the electromagnetic relays increase. In both the electromagnetic relays illustrated in FIGS. 1 and 2, the temperature of the movable spring 30 is highest among the other components of each of the electromagnetic relays when electric current flow in each of the electromagnetic relays illustrated in FIGS. 1 and 2. FIG. 7C is a graph illustrating the relationship between the electric currents and the temperatures of the movable spring 30 shown in FIGS. 7A and 7B. In FIG. 7C, line 7a represents a relationship between the electric current flowing in the electromagnetic relay 100 illustrated in FIG. 1 and the temperature of the movable spring 30 of the electromagnetic relay 100 illustrated in FIG. 1. Line 7b represents a relationship between the electric current flowing in the electromagnetic relay illustrated in FIG. 2 and the temperature of the movable spring 30 illustrated in FIG. 2.

As illustrated in lines 7a and 7b of FIG. 7C, the amount of electric current flowing in the electromagnetic relay 100 illustrated in FIG. 1 is approximately twice the amount of electric current flowing in the electromagnetic relay illustrated in FIG. 2 in the same saturated temperature. This is because in the electromagnetic relay 100 illustrated in FIG. 1, the conductive member 40 having the same thickness as the spring 31 is connected to the movable spring 30. Thereby, the heat of the movable spring 30 of the electromagnetic relay 100 illustrated in FIG. 1 can be controlled to a low temperature even if the same of amount of electric current flows in the electromagnetic relays illustrated in FIGS. 1 and 2.

A resin such as mold resin is used to form the housing of the electromagnetic relay 100, and the melting temperature of the mold resin is approximately 225° C. Therefore, if the saturated temperature exceeds 225° C., the mold resin forming the electromagnetic relay 100 would melt. Even if the saturated temperature is lower than 225° C., the mold resin would begin to deform and the electromagnetic relay 100 is damaged when the saturated temperature exceeds 200° C. Therefore, the electric current that causes the saturated temperature to be less than or equal to 200° C. may be set as the maximum amount of electric current that is allowed to flow in the electromagnetic relay 100. According to FIG. 7C, the maximum amount of electric current that is allowed to flow in the electromagnetic relay illustrated in FIG. 2 when the saturated temperature of the spring 31 is less than or equal to 200° C. is approximately 50 A whereas the maximum amount of electric current that is allowed to flow in the electromagnetic relay 100 illustrated in FIG. 1 when the saturated temperature of the spring 31 is less than or equal to 200° C. is approximately 100 A. Therefore, the electromagnetic relay 100 illustrated in FIG. 1 allows electric current to flow approximately twice the amount compared to the electric current allowed to flow in the electromagnetic relay illustrated in FIG. 2.

Although the amount of electric current allowed to flow in the electromagnetic relay 100 of this embodiment can be increased, the below-described “partial contact” may occur due to the increase of thickness of the movable spring 30 or the overlapping of components. To prevent such partial contact, the structures of the second to fifth embodiments of the present invention are proposed.

### Second Embodiment

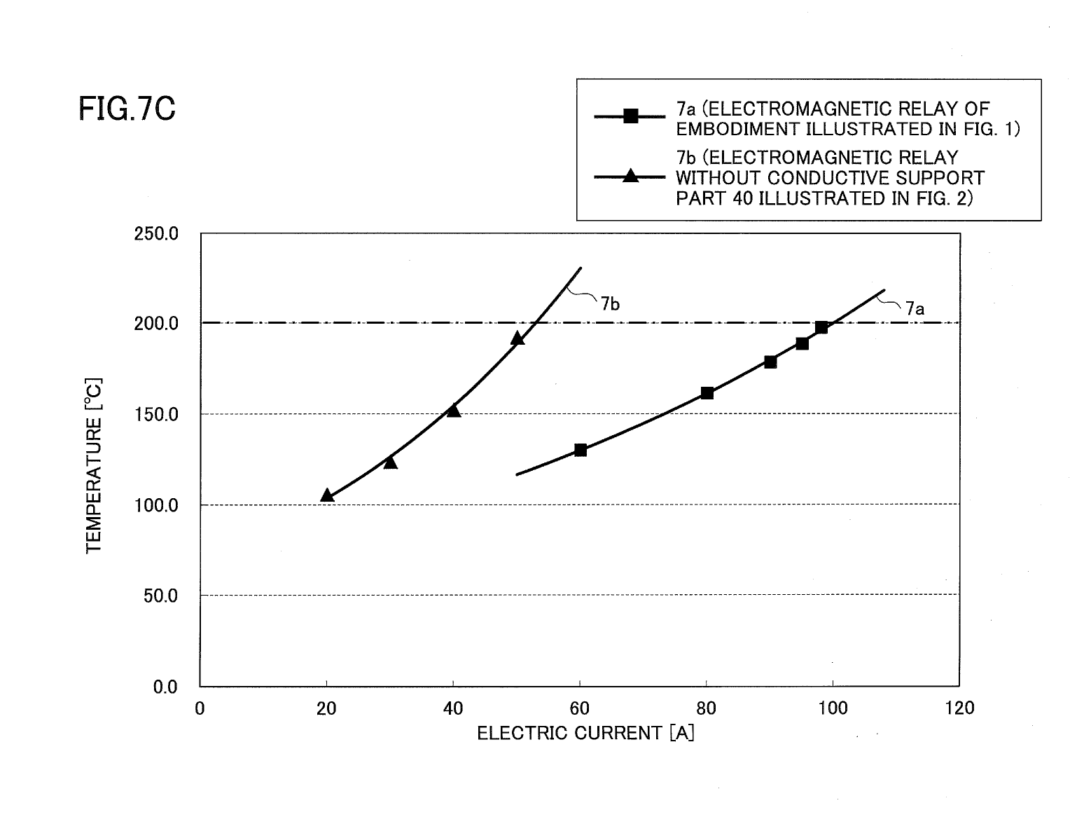

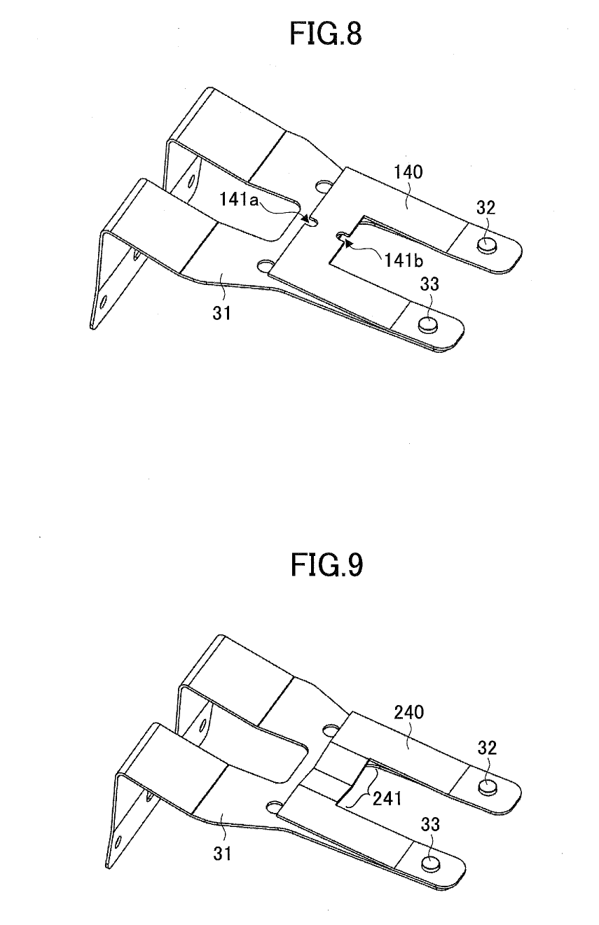

Next, the second embodiment is described. As illustrated in FIG. 8, notches 141a, 141b are formed at a center portion of the U-shaped conductive member 140. By providing the notches 141a, 141b, the so-called “partial contact” can be prevented. The term “partial contact” refers to a state where there is only one of the pair of the first fixed contact 11 and the first movable contact 32 or the pair of the second fixed contact 21 and the second movable contact 33 makes contact. In the partial contact, electric current cannot flow in the electromagnetic relay 100.

In the second embodiment, by providing the notches 141a, 141b at the center portion of the U-shaped conductive member 140, the width of the conductive member 140 can be reduced to alleviate the interlocking effect between a side of the conductive member 140 to be attached to the first movable contact 32 and a side of the conductive member 140 to be attached to the second movable contact 33. In this embodiment, the partial contact can be prevented because the first movable contact 32 and second movable contact 33 can move more freely with respect to each other. The conductive member 140 may be fabricated by punching a metal plate formed of copper or the like. Similar to the first embodiment, the conductive member 140 is connected to the spring 31 by the first and second movable contacts 32, 33.

### Third Embodiment

Next, the third embodiment is described. As illustrated in FIG. 9, a V-shaped bent part 241 is formed at a center of a U-shaped conductive member 240. Similar to the first embodiment, the conductive member 240 is connected to the spring 31 by the first and second movable contacts 32, 33. By providing the V-shaped bent part 241, the interlocking effect between a side of the conductive member 240 to be attached to the first movable contact 32 and a side of the conductive member 240 to be attached to the second movable contact 33 can be alleviated. In this embodiment, partial contact can be prevented because the first and second movable contacts 32, 33 can move more freely with respect to each other. The conductive member 240 is fabricated by performing a punching process on a metal plate formed of copper or the like and bending a center portion of the metal plate.

### Fourth Embodiment

Next, the fourth embodiment is described. As illustrated in FIG. 10, a corrugated part 341 having a corrugated surface is formed at a center portion of a U-shaped conductive member 340. Similar to the first embodiment, the conductive member 340 is connected to the spring 31 of the movable spring 30 by way of the first and second movable contacts 32, 33. By providing the corrugated part 341, the interlocking effect between a side of the conductive member 340 to be attached to the first movable contact 32 and a side of the conductive member 340 to be attached to the second movable contact 33 can be alleviated. Thereby, partial contact can be prevented because the first and second movable contacts 32, 33 can move more freely with respect to each other. The conductive member 340 is fabricated by performing a punching process on a metal plate formed of copper or the like and performing a pressing process on the metal plate.

### Fifth Embodiment

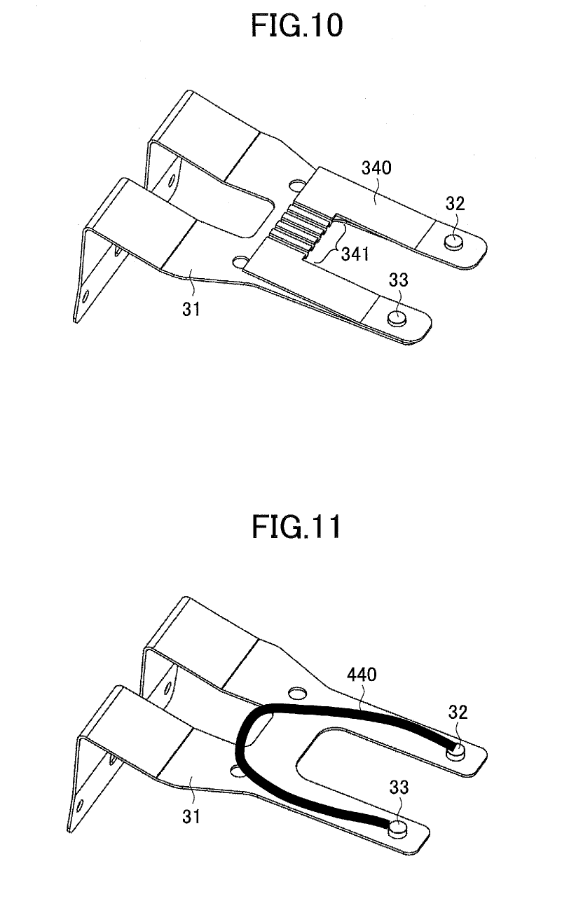

Next, the fifth embodiment is described. As illustrated in FIG. 11, a conductive member is formed by a lead wire 440. In the example illustrated in FIG. 11, the first movable contact 32 and the second movable contact 33 are connected by a lead wire 440 which is a braided wire formed of a metal such as copper or the like. By connecting the first movable contact 32 and the second movable contact 33 with the lead wire 440, the interlocking effect between a side of the conductive member to be attached to the first movable contact 32 and a side of the conductive member to be attached to the second movable contact 33 can be alleviated. Thereby, partial contact can be prevented because the first and second movable contacts 32, 33 can move more freely with respect to each other. In the fifth embodiment, the lead wire 440 is formed with a wire rod having a conductive property. By using the lead wire 440 which is a braided wire formed by braiding multiple thin metal wires, the degree of freedom of the first movable contact 32 and the second movable contact 33 can be increased to further prevent partial contact.

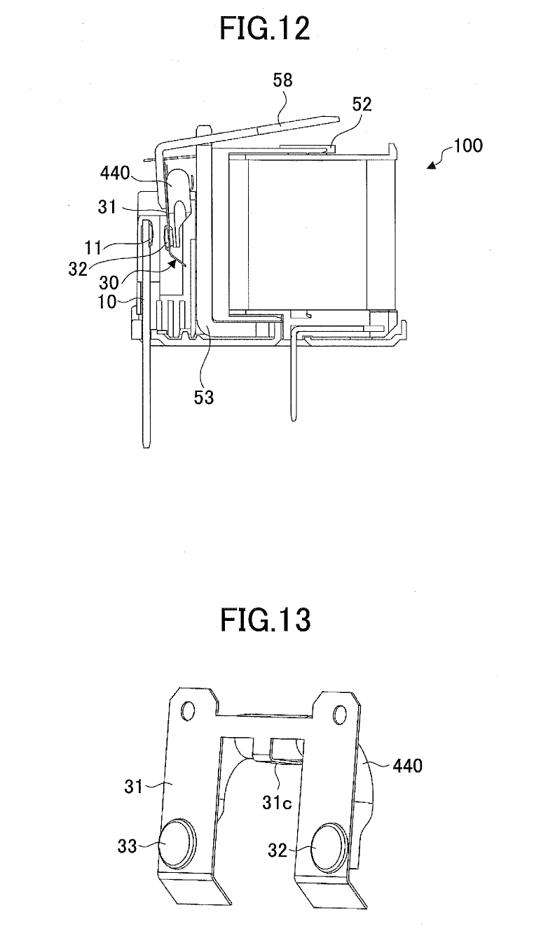

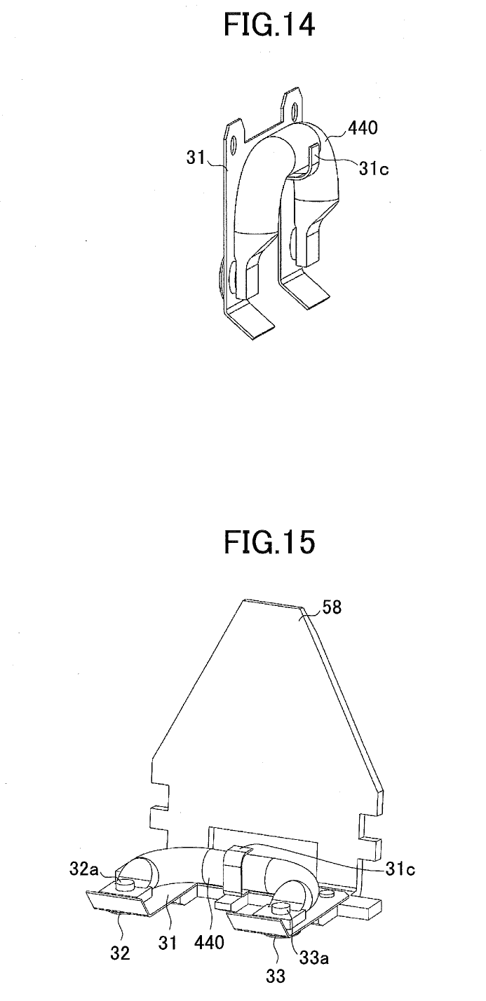

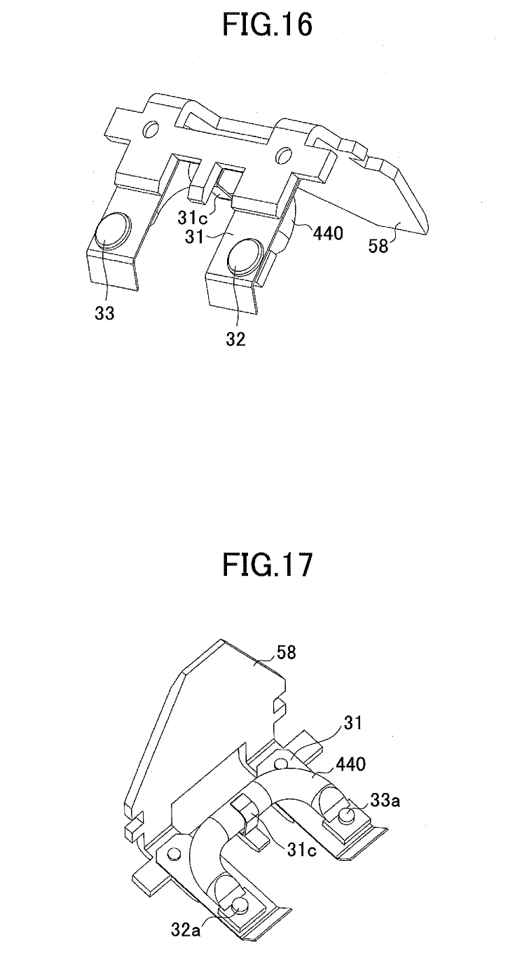

Alternatively, the electromagnetic relay may have a structure as illustrated in FIGS. 12-17. FIG. 12 is a side view illustrating the electromagnetic relay 100 of another example of the fifth embodiment. FIGS. 13 and 14 are perspective views of the movable spring 30 observed from different views in which the lead wire 440 is connected to spring part 31. FIGS. 15-17 are perspective views illustrating the movable spring 30 in which the lead wire 440 is caulked by the spring part 31 and an armature 58 is attached to the movable spring 30.

The electromagnetic relay 100 of FIG. 12 includes an L-shaped armature 58. The first fixed spring 10 and the second fixed spring 20 are formed in a linear shape. A first fixed contact 11 is provided in the vicinity of one end of a first fixed spring 10, and a second fixed contact is provided in the vicinity of one end of a second fixed spring (the second fixed contact and the second fixed spring are not illustrated in FIG. 12). In the electromagnetic relay 100 of FIG. 12, a magnetic field generated by the electric current flowing through the coil 50 attracts the armature 58 to the core 52 and moves the movable spring 30, so that the first movable contact 32 contacts the first fixed contact 11 and the second movable contact 33 contacts the second fixed contact 21. Further, when the magnetic field is terminated by stopping the flow of electric current in the coil 50, the recovering force of the spring part 31 of the movable spring 30 separates the armature 58 from the core 52.

In the electromagnetic relay 100 of FIG. 12, the spring part 31 of the movable spring 30 may be caulked to the lead wire 440. Specifically, a hole provided in the spring part 31 of the movable spring 30 and a hole provided in one end of the lead wire 440 may fastened by a caulking part 32a of the first movable contact 32. Further, a hole provided in the spring part 31 of the movable spring 30 and a hole provided in another end of the lead wire 440 may be fastened by a caulking part 33a of the second movable contact 33.

The lead wire 440 may be fixed by being pinched by a guide 31c provided in the spring part 31 of the movable spring 30. The lead wire 440 may be an annealed copper wire. As methods for connecting the spring part 31 of the movable spring 30 and the lead wire 440 besides a caulking, a resistance welding or a soldering may be used.

With the electromagnetic relay of the above-described embodiments of the present invention, contacts can move independent from each other while still being able to reduce the load applied on the springs, reduce the number of components, prevent size-increase, and increase the flow amount of electric current.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

1. An electromagnetic relay comprising:
a first fixed spring including a first fixed contact;
a second fixed spring including a second fixed contact;
a movable spring including a spring, a first movable contact is connected a first end of the spring, and a second movable contact is connected to a second end of the spring; and
a conductive member, one end connected to the first movable contact and another end connected to the second movable contact.

2. The electromagnetic relay as claimed in claim 1, wherein a thickness of the conductive member is greater than or equal to a thickness of the spring part.

3. The electromagnetic relay as claimed in claim 1, wherein notches are formed in an area of the conductive member between the one end and the another end of the conductive member, so that the area of the conductive member becomes narrower.

4. The electromagnetic relay as claimed in claim 1, wherein a portion of the conductive member between the one end and the another end of the conductive member is bent.

5. The electromagnetic relay as claimed in claim 1, wherein a corrugated part having a corrugated shape is formed in an area of the conductive member between the one end and the another end of the conductive member.

6. The electromagnetic relay as claimed in claim 1, wherein the conductive member is a metal wire.

7. The electric relay as claimed in claim 1, further comprising:
a coil for generating a magnetic force that causes the movable spring to move the first movable contact to contact the first fixed contact and the second movable contact to contact the second fixed contact.
